(19) United States
(12) Patent Application Publication
(10) Pub. No.: US 2009/0075014 A1
(43) Pub. Date: Mar. 19, 2009

(54) OPTICAL RECORDING METHOD AND REPRODUCING METHOD

(75) Inventors: Takeshi Miki, Tokyo (JP); Tsutomu Sato, Yokohama-shi (JP); Tatsuya Tomura, Tokyo (JP); Mikiko Takada, Kawasaki-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/208,931

(22) Filed: Sep. 11, 2008

(30) Foreign Application Priority Data
Sep. 13, 2007 (JP) 2007-238027

(51) Int. Cl. B29C 35/08

(52) U.S. Cl. 428/64.4; 264/405

(57) ABSTRACT

A method of recording on an optical recording medium which comprises a multi-photon absorption material and fine particles which have an sensitizing effect of enhancing a multi-photon absorption process of the multi-photon absorption material by a plasmon-enhanced field having anisotropy, the method including: deactivating the sensitizing effect of a part of the fine particles by deforming the part of the fine particles.

### BACKGROUND OF THE INVENTION

1. Field of the Invention

The present invention relates to an optical recording method, reproducing method, optical recording medium, and a three-dimensional optical recording medium, more specifically to an optical recording method and reproducing method, which record on or reproduce from an optical recording medium based on the presence of sensitizing means.

2. Description of the Related Art

In parallel with a super-resolution technology using a micro aperture, technologies have been developed that aim to achieve an effect comparable to that of a technology that uses a beam spot smaller than a readout-beam spot, by employing as recording material for the recording layer a material that offers non-linear optical characteristics (Japanese Patent Application Laid-Open (JP-A) No. 2000-348377). One example of such a technology is a recording technology that exploits a two-photon absorption process, a phenomenon where two photons, the energy of each of which is half that of one photon in a one-photon absorption process, are absorbed simultaneously, so that the two-photon absorption process provides the same effect as the one-photon absorption process. The likelihood that the two-photon absorption process occurs is proportional to the square of the light intensity (square effect). Specifically, since two-photon absorption occurs only at a high-light intensity point in the vicinity of the optical axis of the beam, it is possible to obtain as great an effect as that obtained with a much smaller beam spot. Due to this square effect, it is highly likely that two-photon absorption occurs only in the vicinity of the focused spot. This feature provides a two-photon absorption-based recording/reproducing technology with a high resolving power in the depth direction as well as in the horizontal direction, compared to that of a one-photon absorption-based one. Namely, in the recording layer, less light is absorbed at positions other than the focused spot. Even in cases where multiple recording layers are stacked on top of each other in the depth direction, two-photon absorption can be effected only in a recording layer of interest. Two-photon absorption-based recording technologies that employ this phenomenon in the writing means are disclosed in A. Toriumi et. al., Opt. Lett. 23, 1924(1998), M. S. Akselrod et. al., MC4, International Symposium on Optical Memory and Optical Data Storage (2005) R. H. Hamer et. al., MC1, International Symposium on Optical Memory and Optical Data Storage (2005).

Attempts have been made to develop optical recording media having several tens of recording layers (three-dimensional optical recording media) by exploiting this two-photon recording technology.

One specific proposed method is a recording/reproducing method that includes the steps of performing recording (writing) by use of two-photon absorption of a two-photon absorption material, and performing reproducing (reading) by detection of reflectivity changes in the recorded portions that occur due to changes in their refractive index. This method employs a photochromic material, a material whose absorption spectrum changes by light absorption, in the recording layer and detects reflectivity changes as with CDs and DVDs. Nevertheless, this method is unable to obtain high resolution exceeding the spot size since it employs one-photon absorption (linear process) for reproduction, although it employs two-photon absorption for recording. Moreover, when several tens of recording layers are laminated to constitute a multilayered recording layer, each recording layer offers a reflectivity of around 1% and, therefore, it becomes difficult to ensure high S/N ratios upon reading.

To avoid this there have been suggested a method that involves use of two-photon absorption even for reproduction, i.e., a method that detects fluorescence emitted from the medium (JP-A No. 2006-330683).

In order for the two-photon absorption-based technology disclosed by JP-A No. 2006-330683 to achieve reproduction of information by detecting fluorescence from the medium, it is necessary upon recording to partially apply a high-energy beam for thermal decomposition of the two-photon absorption material at irradiated portions. However, this requires higher recording beam energy and thereby necessitates the use of a large laser beam source such as a femtosecond pulse laser.

### BRIEF SUMMARY OF THE INVENTION

It is therefore an object of the present invention to provide optical recording and reproducing methods capable of high-density reproduction by detection of fluorescence from the medium by use of two-photon absorption, even when the medium has been written by a low-energy recording beam such as a semiconductor laser beam.

The optical recording method, optical reproducing method, optical recording medium, and three-dimensional optical recording medium according to the present invention have the technical features recited in the following items <1> to <11>.

<1> A method of recording on an optical recording medium which comprises a multi-photon absorption material and fine particles which have an sensitizing effect of enhancing a multi-photon absorption process of the multi-photon absorption material by a plasmon-enhanced field having anisotropy, the method including: deactivating the sensitizing effect of a part of the fine particles by deforming the part of the fine particles.

Deformation of the fine particles having anisotropy can be achieved in any desired manner; however, since it is necessary to deform only fine particles corresponding to recording pits, thermal deformation by means of absorption of a recording beam is most preferable. The size of the fine particles is smaller than the wavelength of the recoding beam, and therefore, they inherently offer large surface energy and readily undergo deformation by absorption of smaller thermal energy. After deformed, they begin to assume a spherical shape, which is the most stable shape, i.e., their aspect ratio decreases, so too does the sensitizing effect attained by a plasmon-enhanced field. A SiO₂ coat or the like may be provided on the fine particle surface in order to control the threshold energy at which they are thermally deformed. Alternatively, it is possible to employ composite particles consisting of shape-anisotropic sites and plasmon-enhancing effect sites, e.g., shape-anisotropic fine particles in which metal that generates a plasmon-enhanced field covers at least a part of the fine particle surface.

With the configuration of <1> above, information at the focal point of the optical probe is exclusively obtained since a two-photon absorption process, one type of a multi-photon absorption process, shows an excitation rate that is proportional to the square of the incident intensity. More specifically, the level of the sensitizing effect only at the focal point of the optical probe is used as information. This is in contrast to a one-photon absorption process where information obtained by the optical probe is the superimposition of all pieces of information over the entire region through which the optical probe passes. With a higher-order multi-photon absorption process, the level of sensitizing effect within a more limited area can be pinpointed and whereby high-resolving power reproduction is made possible.

<2> The method according to <1>, wherein the deactivation is carried out by application of a pulse beam.

In order to perform tracking servo and focusing servo using the same beam as a beam used for deformation of fine particles during recording, it is necessary to apply a servo beam to non-recording portions as well. If a continuous beam is applied as a recording beam there is fear that fine particles of non-recording portions are deformed by another continuous beam applied as a servo beam, because the continuous beam has a relatively high average power. With the configuration of <2> above, fine particles of non-recording portions are not deformed inadvertently since a pulse beam is employed as a recording beam and thereby the average power acting on fine particles can be made lower than that of a continuous beam.

<3> The method according to <2>, wherein the deactivation is carried out by changing the intensity of the pulse beam.

With the configuration of <3> above, it is possible to easily employ the inventive method since the modulation scheme is an extension of a modulation scheme for conventional optical discs.

<4> The method according to <2>, wherein the deactivation is carried out by changing the pulse width of the pulse beam.

Excitation of a multi-photon absorption process requires a high optical power density. If such a high power density is used for a CW beam, deformation of anisotropic fine particles readily occurs while the absorbed light is converting to heat, and thus it becomes difficult to introduce a required optical power density. With the configuration of <4> above, the use of a pulse beam having low average power but having high peak power leads to a state where high peak power acts upon multi-photon excitation while low average power acts upon anisotropic fine particles. In such a state reproduction durability can be readily ensured. From the view point of the scan speed of optical probe, deformation of anisotropic fine particles can be effected even without changing the average power by increasing the pulse width to an extent that the beam can be deemed as a CW beam. Namely, write control is made possible by modulation of pulse width.

<5> The method according to <2>, wherein the deactivation is carried out by changing the intensity and pulse width of the pulse beam.

With the configuration of the item <5> above, the pulse width required for writing becomes small and thereby higher-speed writing is made possible.

<6> The method according to any one of <1> to <5>, wherein the fine particles are gold nanorods.

With the configuration of the item <6>, the fine particles have chemical stability and can be produced in bulk at low costs. This is because gold nanorods are anisotropic metallic fine particles with uniform aspect ratios, which themselves show plasmon enhancing effect, and because a solvent growth method has been established as a mass production method.

<7> A method of reproducing from an optical recording medium written by the recording method according to any one of <1> to <6>, the reproducing method including: applying a reproduction beam to cause the multi-photon absorption material, which has absorbed multiple photons by the sensitizing effect of non-deactivated fine particles of the fine particles, to emit fluorescence; and detecting the intensity of the fluorescence for reproduction.

<8> The method according to <7>, wherein the reproduction is carried out by detecting only the fluorescence emitted from the multi-photon absorption material that has absorbed multiple photons by the sensitizing effect of the non-deactivated fine particles.

With the configuration of the item <7> or <8> above, the written recording layer has mixed regions of deformed (spherical) fine particles and intact fine particles with the same aspect ratios as they have before writing. The intact fine particles have a near-field region with large enhancing effect, but the deformed or spherical fine particles have enhancing effect that is many orders of magnitude smaller than that of the intact fine particles. Thus, by using an optical probe it is made possible to identify thermally deformed portions and intact portions with unchanged aspect ratios based on the presence or intensity of the enhancing effect, thereby enabling reproduction of recorded information. The phenomenon to be observed using the optical probe is not specifically limited, but is preferably a “reversible” phenomenon (e.g., fluorescence detection) in order to ensure reproduction durability. Fluorescence has a longer wavelength than an excited light beam, and therefore, stray light components due to interlayer reflections and diffraction can be readily removed by a filter. Moreover, by detecting only fluorescence, signal light beams can be detected at high S/N ratios exclusively.

<9> The method according to <7> or <8>, wherein the reproduction beam is a pulse beam.

With the configuration of the item <9> above, a pulse beam is employed as a reproduction beam for reproduction and thereby the peak power acting on the multi-photon absorption material increases and the efficiency of multi-photon absorption increases. As in the case of recording, the reproduction beam never deforms unwanted fine particles inadvertently.

<10> An optical recording medium capable of recording by means of the optical recording method according to any one of <1> to <6>.

With the optical recording medium of the item <10> above, super-resolution is attained both in the horizontal and depth direction of the medium, enabling high-density recording and reproduction.

<11> The optical recording medium according to <10>, wherein the optical recording medium comprises a laminate of multiple recording layers each containing the multi-photon absorption material and the fine particles.

With the configuration of the item <11> above, the optical recording medium has three-dimensional structure. Thus, in addition to the super-resolution effect, the optical recording medium has a higher storage capacity and is capable of higher-density recording and reproduction of information by lamination of recording layers in the depth direction. Needless to mention, “lamination in the depth direction” as used herein encompass not only lamination of recording layers in such a way that they are physically separated from one another by intermediate layers, but manufacture of a homogenous bulk medium in which recording layers are optically separated from one another so that reproduction can be performed for each layer independently.

The optical recording method, optical reproducing method, optical recording medium, and three-dimensional optical recording medium are capable of high-density reproduction by detecting the presence of fluorescence from the medium by use of two-photon absorption, even when the medium has been written with a low-energy recording beam.

### BRIEF DESCRIPTION OF THE SEVERAL VIEWS OF THE DRAWINGS

FIG. 1 is a schematic illustration of a three-dimensional optical recording medium according to the present invention.

FIG. 2 is a schematic illustration of the configuration of a recording media evaluation apparatus.

### DETAILED DESCRIPTION OF THE INVENTION

Hereinafter, an optical recording method and optical reproducing method of the present invention, which record on or reproduce from an optical recording medium based on the presence of sensitizing means, will be described.

It should be noted that the following description is directed to preferred embodiments of the present invention and thus includes various technically preferred limitations thereto. However, the scope and spirit of the present invention shall not be construed as being limited to these preferred embodiments unless otherwise described.

### (Example of Recording Material Composition According to the Present Invention)

The recording material according to the present invention contains, as a plasmon-enhanced field generator, gold nanorods.

Production of gold nanorods themselves may be accomplished by photoreduction method, electroreduction, etc., and there is no limitation as to the production method as long as the resultant gold nanorods are operable as a plasmon-enhanced field generator.

The phenomenon caused by two-photon absorption is not limited to fluorescence generation and a variety of phenomena can also be, of course, applicable.

The two-photon absorption material can be prepared, for example, in accordance with the method disclosed by JP-A No. 2006-330683. Namely, the multi-photon absorption material that constitutes the recording layer according to the present invention is composed of a multi-photon absorption material made of multi-photon absorption dye or the like, and of either a dispersion liquid of metal fine particles that generate a surface plasmon-enhanced field or a dispersion liquid of fine particles at least partially covered with those metal fine particles. Provision of an inorganic protective film (e.g., SiO₂ film) to the gold nanorods can increase the reproduction durability. Moreover, reducing the thickness of the inorganic protective film to a minimum required level lowers the threshold of “deactivation” of the plasmon-enhanced field by deformation of gold nanorods upon recording, thereby making high-sensitivity recording possible.

Deactivation of plasmon-enhanced field by deformation of gold nanorods means to produce deformed (spherical) gold nanorods by irradiation gold nanorods with a recording beam. On the other hand, that the plasmon-enhanced field is not deactivated (non-deactivation of plasmon-enhanced field) means that the aspect ratios of gold nanorods are kept at the same level as before the application of a recording beam, i.e., to prevent gold nanorods from structural changes. In the deactivation step certain fine particles are selectively deformed by irradiation with a recording beam, creating a state where deactivated fine particles and non-deactivated fine particles coexist. The fine particle are smaller in diameter than the wavelengths of recording/reproduction beams; therefore, they have large surface energy and readily undergo deformation with small thermal energy. After deformed, they begin to assume a spherical shape, which is the most stable shape, i.e., their aspect ratio decreases. Accordingly, the sensitizing effect of the deformed fine particles by the plasmon-enhanced field will be many orders of magnitude smaller than that of non-deformed fine particles.

Application of a low-energy recording beam allows areas where the aspect ratios of fine particles are retained for high enhancing effect and areas where fine particles are deformed for low enhancing effect to coexist. As a consequence, when the areas where the aspect ratios of fine particles are retained are irradiated with a reproduction beam, strong fluorescence is detected at those areas by virtue of high enhancing effect. By contrast, due to reduced enhancing effect, only weak fluorescence (or no fluorescence) is detected at those areas where fine particles are deformed. By measuring the intensity (presence) of fluorescence it is possible to identify areas where the aspect ratios of fine particles are retained and areas where fine particles are deformed, making reproduction of the recorded information possible. (Example of the Configurations of Multilayer Recording Medium and Recording/Reproducing System According to the Present Invention)

As used herein, “multi-photon absorption material” encompasses two-photon absorption material and materials absorbing two or more photons.

A basic structure of an optical recording medium according to the present invention including a multi-photon absorption material can be manufactured by directly applying on a given substrate (base) a multi-photon absorption material by use of a spin coater, roll coater, or bar coater, or by casting a multi-photon absorption material film on a given substrate (base).

As the above substrate (base), it is possible to employ any naturally-occurring or synthetic substrate, preferably a flexible or rigid film, sheet or plate.

Specific materials of the substrate (base) include polyethylene terephthalate, resin-under coated polyethylene terephthalate, polyethylene terephthalate subjected to flame or electrostatic discharge treatment, cellulose acetate, polycarbonate, polymethylmethacrylate, polyester, polyvinyl alcohol, and glass.

In advance, given tracking grooves may be formed or pre-formatted address information may be provided depending on the intended purpose of the resultant recording medium.

When the multi-photon absorption material is to be provided using a coating method, the solvent used is removed by evaporation during drying. Removal of solvent by evaporation may be accomplished either by heating or vacuuming.

For the purpose of oxygen blocking or prevention of interlayer crosstalk, a given protective (intermediate) layer may further be provided on the multi-photon absorption material formed by coating or casting.

The protective (intermediate) layer can be provided as follows: A plastic film or plate made of polyolefin (e.g., polypropylene, polyethylene), polyvinyl chloride, polyvinylidene chloride, polyvinyl alcohol, polyethylene terephthalate, or cellophane is attached to the layer of multi-photon absorption material by either electrostatic attachment or lamination using an extruder. Alternatively, the protective layer may be provided by coating a polymer solution containing the above polymer(s). A glass plate may also be employed.

Moreover, an adhesive or liquid substance may be provided for the purpose of enhancing airtightness between them. In the protective layer, given tracking grooves may be formed or pre-formatted address information may be provided depending on the intended purpose of the resultant recording medium.

Recording and/or reproduction are carried out at a given recording layer of the recording medium that has three-dimensional multilayered structure containing the multi-photon absorption material.

The optical recording medium according to the present invention is capable of three-dimensional recording by virtue of multi-photon absorption material characteristics, even when the recording layers are not separated from one another by protective (intermediate) layers

By way of a specific example of a three-dimensional recording medium according to the present invention containing a multi-photon absorption material, a preferred embodiment of a three-dimensional multilayered optical memory will be described hereinafter.

It should be specifically noted that the following embodiment shall not be construed as limiting the scope of the present invention; the three-dimensional multilayered memory may have another structure as long as it is capable of three-dimensional recording (i.e., recording both in horizontal and depth directions)

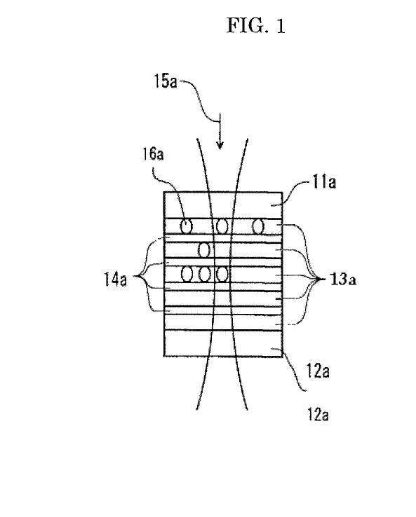

FIG. 1 shows a schematic cross section of a three-dimensional optical recording medium according to the present invention.

The three-dimensional optical recording medium 10 shown in FIG. 1 includes a flat support (substrate 11a), and 50 recording layers 13a and 50 protective (intermediate) layers 14a alternately deposited onto the substrate 11a by spin coating. The recoding layers 13a contain a multi-photon absorption compound and gold nanorods, and the protective (intermediate) layers 14a are intended for prevention of interlayer crosstalk.

The thickness of each recording layer 13a is set to 0.01 μm to 0.5 μm, and each intermediate layer 14a is suitably set to 0.5 μm to 5 μm.

The above-described media configuration makes it possible to realize ultrahigh-density optical recording of the order of terabytes using the same disc size as traditional CDs and DVDs.

Depending on the data reproduction scheme (i.e., transparent type or reflective type), a substrate 12a (protective layer) similar to the substrate 11a or a reflective layer 12a′ made of highly reflective material is provided on the recording layer 13a (intermediate layer 14a) farthest from the substrate 11a.

For the formation of recording bits 16a, a single beam (laser beam 15a in the drawing) is used that is a ultra-short pulse beam of the order of femtoseconds.

Upon reproduction, a beam that has a different wavelength than the data recording beam may be used, or a low-power beam that has the same wavelength as the data recording beam may be used.

Recording and reproduction are possible both on a bit basis and on a page basis. Parallel recoding/reproduction using a surface light source and a two-dimensional detector is effective in increasing the transfer rate.

The form of the three-dimensional multilayered optical memory manufactured in accordance with the present invention is, for example, a card shape, plate shape, or drum shape.

### EXAMPLES

The present invention will be detailed with reference to Examples and Comparative Examples. These Examples are, however, each directed to an example of the structure of the present invention and thus shall not be construed as limiting the scope of the invention thereto.

### Example 1

0.18 mol/l cetyl trimethyl ammonium bromide aqueous solution (70 ml), cyclohexane (0.36 ml), acetone (1 ml), and 0.1 mol/l silver nitrate aqueous solution (1.3 ml) were mixed and stirred. To this mixture was added 0.3 ml of 0.24 mol/l chloroauric acid aqueous solution followed by addition of 0.3 ml of 0.1 mol/l ascorbic acid aqueous solution. The color derived from chloroauric acid disappeared. Thereafter, the resultant solution was poured into a petri dish and irradiated with UV light (wavelength=254 nm) using a low-pressure mercury lamp for 20 minutes. In this way a dispersion liquid of gold nanorods with an absorption wavelength of around 830 nm was obtained. The dispersion liquid was centrifuged to sediment gold nanorods, the supernatant was discarded, water was added to the gold nanorods, and centrifuged again. This process was repeated several times for the complete removal of excess cetyl trimethyl ammonium bromide used as a dispersant. 1 g of the gold nanorod dispersion liquid was mixed with 0.4 g of 1 wt % acetone solution of polyethyleneimine (Wako Pure Chemical Industries, Ltd., average molecular weight=1,800). To this mixture was added 2 g of 5 wt % DMF solution of acrylic resin DIANAL BR-75 (Mitsubishi Rayon Co., Ltd.) and mixed, and 0.7 mg of two-photon fluorescent dye having the following Formula (1) was added and mixed. The mixture was concentrated under reduced pressure to a volume of several milliliters. After disposing a frame onto a glass substrate, the solution was poured on the glass substrate, and the solvent was volatilized for solidification. In this way an acrylic resin bulk with dispersed gold nanorods and two-photon fluorescent dye, which had a thickness of 50 μm, was fabricated.

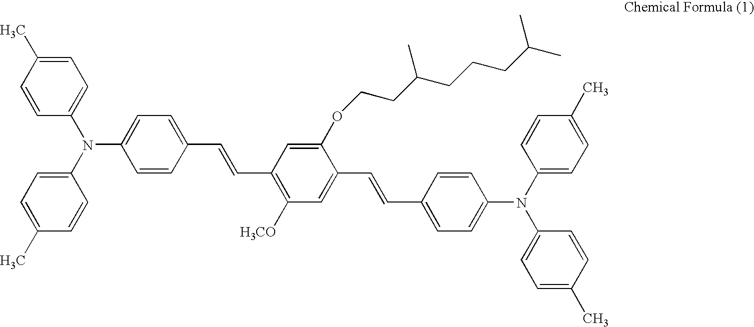

### Example 2

To 5 ml of the gold nanorod dispersion liquid prepared in Example 1 was added 10 ml of 1 vol % acetone solution of (3-aminopropyl)ethyldiethoxysilane, and heated at 80° C. for 2 hours to produce a SiO₂ coat on the surfaces of gold nanorods. In this way gold nanorods with a SiO₂ coat were prepared. To the gold nanorods, 5 ml of cyclohexane was added and stirred to prepare a cyclohexane dispersion liquid of the gold nanorods with a SiO₂ coat. Any oil solvent can be appropriately employed for the preparation of the gold nanorods. As to the method of dispersing gold nanorods, any surfactant, including thiol group-containing surfactants, can be employed depending on the type of the oil solvent and dispersing characteristics. This dispersion liquid was centrifuged to sediment gold nanorods having a SiO₂ coat. The supernatant was discarded, and 1 g of the remained dispersion liquid was mixed with 0.4 g of 1 wt % acetone solution of polyethyleneimine (Wako Pure Chemical Industries, Ltd., average molecular weight=1,800). To this mixture was added 2 g of 5 wt % DMF solution of acrylic resin DIANAL BR-75 (Mitsubishi Rayon Co., Ltd.) and mixed, and 0.7 mg of two-photon fluorescent dye having the above Formula (1) was added and mixed. The mixture was concentrated under reduced pressure to a volume of several milliliters. After disposing a frame onto a glass substrate, the solution was poured onto the glass substrate, and the solvent was volatilized for solidification. In this way an acrylic resin bulk with dispersed gold nanorods having a SiO₂ coat and two-photon fluorescent dye, which had a thickness of 50 μm, was fabricated.

### Example 3

1 g of the gold nanorod dispersion liquid prepared in Example 1 was mixed with 0.4 g of 1 wt % acetone solution of polyethyleneimine (Wako Pure Chemical Industries, Ltd., average molecular weight=1,800). To this mixture was added 2 g of 5 wt % DMF solution of acrylic resin DIANAL BR-75 (Mitsubishi Rayon Co., Ltd.) and mixed, and 0.7 mg of two-photon fluorescent dye having the above Formula (1) was added and mixed. The mixture was concentrated under reduced pressure to a volume of several milliliters. This mixture was applied onto a glass substrate by spin coating to form a 0.5 μm thick acrylic resin film, and a 5 wt % PVA aqueous solution was applied thereon by spin coating to form a 5 μm thick PVA film. By repeating this step, acrylic resin films and PVA films (thickness=5 μm) were alternately formed by spin coating. In this way a laminate was fabricated that consists of 5 alternating PVA layers and acrylic resin layers that have dispersed gold nanorods and two-photo fluorescent dye.

### Example 4

To 5 ml of the gold nanorod dispersion liquid prepared in Example 1 was added 10 ml of 1 vol % acetone solution of (3-aminopropyl)ethyldiethoxysilane, and heated at 80° C. for 2 hours to produce a SiO₂ coat on the surfaces of gold nanorods. In this way gold nanorods with a SiO₂ coat were prepared. To the gold nanorods, 5 ml of cyclohexane was added and stirred to prepare a cyclohexane dispersion liquid of the gold nanorods with a SiO₂ coat. Any oil solvent can be appropriately employed for the preparation of the gold nanorods. As to the method of dispersing gold nanorods, any surfactant, including thiol group-containing surfactants, can be employed depending on the type of the oil solvent and dispersing characteristics. 0.05 ml of 0.01 mol/l acetone solution of silver nitrate was added to 5 ml of the cyclohexane dispersion liquid, and ten aliquots of 0.005 ml of 0.01 mol/l acetone solution of ascorbic acid were sequentially added with stirring (total amount=0.05 ml) to induce chemical reduction. Metallic silver generated by chemical reduction covered the SiO2 coat provided on the dispersed fine particles. The intended thickness of the metallic silver coat can be obtained by adjustment of the added amount of silver nitrate. In this way a dispersion liquid of composite nanoparticles having gold nanorods as a core was prepared. This dispersion liquid was centrifuged to sediment composite nanoparticle components having gold nanorods as a core. The supernatant was discarded, and 1 g of the resultant dispersion liquid was mixed with 0.4 g of 1 wt % acetone solution of polyethyleneimine (Wako Pure Chemical Industries, Ltd., average molecular weight=1,800). To this mixture was added 2 g of 5 wt % DMF solution of acrylic resin DIANAL BR-75 (Mitsubishi Rayon Co., Ltd.) and mixed, and 0.7 mg of two-photon fluorescent dye having the above Formula (1) was added and mixed. The mixture was concentrated under reduced pressure to a volume of several milliliters. After disposing a frame onto a glass substrate, the solution was poured onto the glass substrate, and the solvent was volatilized for solidification. In this way an acrylic resin bulk with dispersed composite nanoparticles having gold nanorods as a core and two-photon fluorescent dye, which had a thickness of 50 μm, was fabricated.

### Comparative Example 1

To 2 g of 5 wt % DMF solution of acrylic resin DIANAL BR-75 (Mitsubishi Rayon Co., Ltd.) was added 0.7 mg of two-photon fluorescent dye having the above Formula (1) and mixed. After the dye was dissolved. a frame was disposed onto a glass substrate, the solution was poured onto the glass substrate, and the solvent was volatilized for solidification. In this way an acrylic resin bulk with dispersed two-photon fluorescent dye, which had a thickness of 50 μm, was fabricated.

### (Measurement Method)

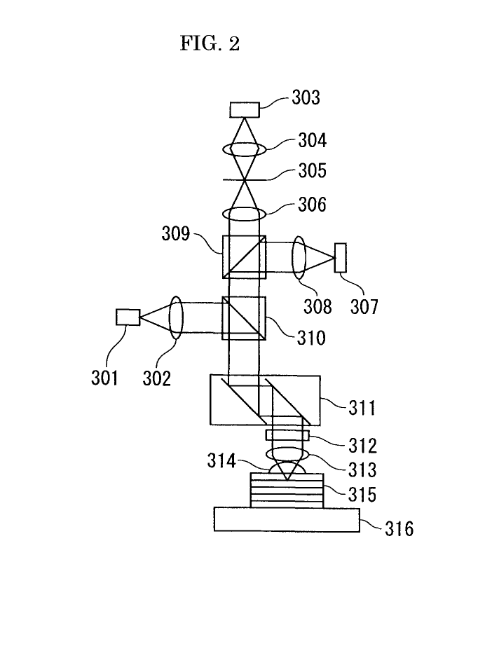

The samples were evaluated using a microscopic evaluation apparatus shown in FIG. 2. With reference to FIG. 2, the evaluation apparatus uses a semiconductor laser 307 (wavelength=780 nm) as a writing/reading beam source. A high-speed modulation pulse power (not shown) was employed for the driving of the semiconductor laser 307. A laser beam passes through a collimator lens 308 to become a parallel beam. The parallel beam then passes through a polarization beam splitter 309 to change the travel direction, and passes through a dichroic mirror 310 to a biaxial galvano-mirror for polarization, whereby a desired view can be obtained. Furthermore, the laser beam is circularly polarized with a quarter wave plate 312, and focused in the sample 315 on a substrate 316 using an immersion objective lens 313 (NA=1.4) with matching oil 314. The reflection beam from the focal point is of opposite circular polarization and travels back the same way the incident beam came. That is, it is linearly polarized by the quarter wave plate, passes through the dichroic mirror 310 to the polarization beam splitter 309, where the beam is separated from the reading beam source. The reflection beam passes through a confocal system consisting of a condenser lens 306, pinhole 305 and relay lens 304, and is detected by a detector 303. Fluorescence emitted from the focal point of the sample is collected by the objective lens 313, passes through the quarter wave plate 312 and biaxial galvano-mirror 311, is separated from the writing/reading beam by the dichroic mirror 310, and is detected by a detector 301 by being focused through a condenser lens 302. Although not shown in the drawing, a cut filter for cutting a writing/reading beam (wavelength=780 nm) may be suitably interposed between the dichroic mirror 310 and detector 301.

### (Evaluation Results)

### Evaluation Result 1

The samples of Examples 1 to 4 were compared with the sample of Comparative Example 1.

Various write sequences as shown in the following Write Sequences 1-3 were used for the recording beam. After one scanning, a reading beam (pulse width=2 ns, repetitive frequency=50 MHz) was applied at a dose of 1 mW (peak power=10 mW) from the objective lens, and fluorescence images were observed. Writing performance was evaluated based on the modulation amplitude of the obtained fluorescence. Evaluations of writing performance set forth in the following Tables 1-3 are based on the ranks of modulation amplitude of fluorescence shown below.

### <<Evaluation Criteria of Modulation Amplitude>>

60% or more: A

40% or more, but less than 60%: B

10% or more, but less than 40%: C

Less than 10%: D

Upon writing a recording layer, for fine particles to be deformed, writing may be carried out using a recording beam that provides the modulation amplitude of 60% or more (i.e., a condition that achieves “A” in the above evaluation). On the other hand, for fine particles not to be deformed, writing may be carried out using a recording beam that provides the modulation amplitude of less than 10% (i.e., a condition that achieves “D” in the above evaluation). More specifically, recording is carried out with the conditions achieving “A” and “D” being alternately employed for the recording beam. This increases the difference in modulation amplitude of fluorescence, and therefore, the intensity of fluorescence, or occurrence of deformation of fine particles, can be readily detected, thereby enabling high-performance reproduction. The conditions for “B” and “C” are, of course, operable although the difference in modulation amplitude of fluorescence is small.

### (Write Sequence 1)

Only the average irradiation dose was changed, with the pulse width fixed to 2 ns and the repetitive frequency fixed to 50 MHz.

TABLE 1

Average irradiation dose

| Sample | 5 mW | 10 mW | 15 mW | 20 mW |
|---|---|---|---|---|
| Ex. 1 | C | A | A | A |
| Ex. 2 | D | C | B | A |
| Ex. 4 | D | B | A | A |
| Comp. Ex. 1 | D | D | D | D |

With the sample of Comparative Example 1 that contains no sensitizing material, there was no choice but to thermally decompose the dye to establish modulation, and no modulation was obtained by merely increasing the recording power by 20-fold. In contrast, it was established that the samples containing the sensitizing material enabled modulation by changing the peak power.

### (Write Sequence 2)

The pulse width and repetitive frequency were changed, with the duty ratio fixed to 10% and average irradiation dose fixed to 1 mW.

TABLE 2

| | Pulse width | | | | |
|---|---|---|---|---|---|
| Sample | 2 ns | 10 ns | 30 ns | 60 ns | 100 ns |
| Ex. 1 | D | C | B | A | A |
| Ex. 2 | D | D | D | B | A |
| Ex. 4 | D | D | C | A | A |
| Comp. Ex. 1 | D | D | D | D | D |

With the sample of Comparative Example 1 that contains no sensitizing material, there was no choice but to thermally decompose the dye to establish modulation, and modulation was obtained by merely increasing the pulse width. In contrast, it was established that the samples containing the sensitizing material enabled modulation by changing the pulse width even without changing the peak power.

### (Write Sequence 3)

The average irradiation power was changed (peak power changed), with the pulse width fixed to 10 ns and duty ratio fixed to 50%.

TABLE 3

Average irradiation dose

| Sample | 1 mW | 3 mW | 5 mW | 7 mW |
|---|---|---|---|---|
| Ex. 1 | D | B | A | A |
| Ex. 2 | D | D | B | A |
| Ex. 4 | D | C | A | A |
| Comp. Ex. 1 | D | D | D | D |

With the sample of Comparative Example 1 that contains no sensitizing material, there was no choice but to thermally decompose the dye to establish modulation, and no modulation was obtained. In contrast, it was established that the samples containing the sensitizing material further lowered threshold by changing the irradiation dose.

### Evaluation Results 2

The laminate prepared in Example 3 was evaluated that consists of alternating PVA layers and acrylic resin layers that have dispersed gold nanorods and two-photo fluorescent dye. The Write Sequence 3 was employed while setting the average irradiation power to 5 mW. Using this condition, recording was carried out such that different recording layers have patterns of different pitches. It was confirmed that each layer showed a modulation amplitude of 60% or more without causing interlayer crosstalk.

From Examples 1 to 4 and Comparative Example 1, it was established that an optical recording method, optical reproducing method, optical recording medium, and three-dimensional optical recording medium can be provided which are capable of high-density reproduction by detecting the presence of fluorescence from the medium by use of two-photon absorption, even when the medium has been written with a low-energy recording beam.

What is claimed is:

1. A method of recording on an optical recording medium which comprises a multi-photon absorption material and fine particles which have an sensitizing effect of enhancing a multi-photon absorption process of the multi-photon absorption material by a plasmon-enhanced field having anisotropy, the method comprising:
deactivating the sensitizing effect of a part of the fine particles by deforming the part of the fine particles.

2. The method according to claim 1, wherein the deactivation is carried out by application of a pulse beam.

3. The method according to claim 2, wherein the deactivation is carried out by changing the intensity of the pulse beam.

4. The method according to claim 2, wherein the deactivation is carried out by changing the pulse width of the pulse beam.

5. The method according to claim 2, wherein the deactivation is carried out by changing the intensity and pulse width of the pulse beam.

6. The method according to claim 1, wherein the fine particles are gold nanorods.

7. A method of reproducing from an optical recording medium which comprises a multi-photon absorption material and fine particles which have an sensitizing effect of enhancing a multi-photon absorption process of the multi-photon absorption material by a plasmon-enhanced field having anisotropy, the recording medium written by a recording method which comprises deactivating the sensitizing effect of a part of the fine particles by deforming the part of the fine particles, the reproducing method comprising:
applying a reproduction beam to cause the multi-photon absorption material, which has absorbed multiple photons by the sensitizing effect of non-deactivated fine particles of the fine particles, to emit fluorescence; and
detecting the intensity of the fluorescence for reproduction.

8. The method according to claim 7, wherein the reproduction is carried out by detecting only the fluorescence emitted from the multi-photon absorption material that has absorbed multiple photons by the sensitizing effect of the non-deactivated fine particles.

9. The method according to claim 7, wherein the reproduction beam is a pulse beam.

10. An optical recording medium comprising:
a multi-photon absorption material; and
fine particles which have an sensitizing effect of enhancing a multi-photon absorption process of the multi-photon absorption material by a plasmon-enhanced field having anisotropy,
wherein the optical recording medium is written by a recording method which comprises deactivating the sensitizing effect of a part of the fine particles by deforming the part of the fine particles.

11. The optical recording medium according to claim 10, wherein the optical recording medium comprises a laminate of multiple recording layers each containing the multi-photon absorption material and the fine particles.
